(19) United States
(12) Patent Application Publication
(10) Pub. No.: US 2007/0266901 A1
(43) Pub. Date: Nov. 22, 2007

(54) ENCAPSULATED COLORANTS FOR WATERBORNE COATING COMPOSITIONS SYSTEM AND KIT AND METHOD

(76) Inventors: DEREK G. RANCE, Strongsville, OH (US); Jamie B. Peltz, Orange Village, OH (US); Kenneth G. Hahn, Hinckley, OH (US); Dennis G. Moore, Vermilion, OH (US)

Correspondence Address: THE GLIDDEN COMPANY, 15885 WEST SPRAGUE ROAD, STRONGVILLE, OH, 44136, US

(21) Appl. No.: 11/697,069

(22) Filed: Apr. 5, 2007

Related U.S. Application Data
(60) Provisional application No. 60/790,265, filed on Apr. 6, 2006.
(60) Provisional application No. 60/790,966, filed on Apr. 11, 2006.

(51) Int. Cl. C09D 17/00; C08K 5/06; C09D 103/14

(52) U.S. Cl. 106/501.1; 106/499

(57) ABSTRACT

Encapsulated colorants for waterborne coating compositions are provided as a system and kit with a method for tinting the water borne coating compositions. The encapsulated colorant comprises at least one water dispersible tinting material to be released into the based coating composition upon dissolution of the encapsulating layer to give the coating composition color. The encapsulating layer surrounding the colorant has at least one polymer that is soluble in aqueous medium surrounding the tinting material wherein the layer has a thickness from about 0.5 to about 5 mils and can dissolve to release the dispersible tinting material in an aqueous coating composition having about 25 to about 45 volume percent solids and about 55 to about 75 volume percent water in less than 15 minutes with agitation at a temperature in the range of about 50 to about 110° F. One or more of the encapsulated colorants as a pouch or pouches are contained in a moisture resistant package until ready for dissolution in the coating composition. A plurality of the encapsulating colorants as pouches in moisture resistant packaging comprise a system which along with one or more clear or tint base water borne coating compositions comprise a kit. A method involves placing one or more pouches in a volume of coating composition with stirring or shaking to provide a color to the composition.

This application claims the benefit including that of priority under 35 U.S.C. 119(e) of U.S. Provisional Patent Applications Ser. No. 60/790,265, filed Apr. 6, 2006, entitled “Encapsulated Colorants for Waterborne Coating Compositions, System, Kit and Method”; and Ser. No. 60/790,966, filed Apr. 11, 2006, also entitled “Encapsulated Colorants for Waterborne Coating Compositions, System, Kit and Method”, the complete disclosures of both of which are hereby incorporated by reference.

### BRIEF DESCRIPTION OF THE DISCLOSURE

The present disclosure relates to encapsulated colorants soluble in waterborne coating compositions for providing color or pigmentation to the coating composition, a system of a plurality of water-soluble packets or pouches of colorants for providing a variety of colors for water-based coating compositions, and methods for pigmenting water-based coating compositions. In particular, various exemplary embodiments of the present invention, relate to water-soluble colorant packets for pigmenting latex paints.

### TECHNICAL CONSIDERATIONS FOR THE DISCLOSURE

Users of water-based or water borne coating compositions such as paint customers can choose from thousands of colors as they plan to coat various substrates. Usually these colors are made available by providing three or four “tint bases” that contain different amounts of titanium dioxide, white pigment, usually between zero and 30% by weight of the total coating formula. In retail establishments, combinations of liquid colorant concentrates are added to achieve this diversity of colors and intensities. Typically, about eight to 12 colorants are dispensed through manually or computer-controlled dosing machines, which dose the coating composition such as a can of paint with the requisite combinations of one or more of the colorants. For example, a light pastel color for a latex paint might require 1 ounce per gallon of a combination of red and yellow colorants in a tint base containing a high level of titanium dioxide, while an intense, bright color might require 10 or more ounces of bright red or blue colorants in a tint base with little or no titanium dioxide. The tinting machines at the retail or point of sale establishment are elaborate and expensive pieces of equipment for volumetrically dispensing the pigment concentrates. The dispensing equipment can be either automatic or manual; for example, a manual dispensing machines is known as the Harbil machine. These machines consist of a canister and a tri-valve pump where material is pulled into the piston from the canister and then dispensed through a 3 mm orifice. The shear rate of the dispensed pigment concentrate has been calculated to be 300 sects based on the diameter of the nozzle orifice (3 mm) and the rate of the dispensing of the concentrate. This type of elaborate equipment makes tinting coating compositions at the point of sale in a store an involved effort over the supply of ready mixed coating compositions. However the consumer does not have the wide variety of choice of colors with the ready mix formulae. Also the consumer reties on the store tinting operation to reproduce a desired color selected from available color swatches depicting dried films of the coating composition with a particular color. At times the consumer may feel the tinted color of the coating appears tighter than the color of the swatch and want more tinter added. However the tinting operation of the store probably treats this as a return of a product and tints another can of coating to a darker shade of the color. Such an approach is cumbersome for the consumer to return the product and get another tinted product Also the involved tinting operation itself limits the selling of coating compositions tinted at the point of sale to stores willing to invest not only in the tinting equipment and tinter concentrates but also the shakers to provide a uniformly tinted product.

while this is the norm in many parts of the world, there are exceptions. For example in Germany and parts of Latin America many customers prefer to create their own colors for coating compositions such as paints for home use. In those cases, the tint base is sold along with bottles of colorants needed to achieve a general color range. The painters add the necessary amounts of color to achieve the color and intensity of color that they like. In some cases, the colorants are pre-measured to give specific colors; in other cases, larger bottles are sold as some customers prefer to be free to develop their own personalized colors without being restricted by pre-measured doses. In any case, the liquid colorant is added and the paint is stirred, typically by hand with a wooden stick or with a stirrer attachment for an electric hand drill for about two minutes to achieve color uniformity.

Dealing with bottles of liquid colorant for paint can be a challenge in its use, and in its reproducibility of the desired color. For instance, a rather sophisticated and neat approach to the use of the liquid colorant and/or rather tedious preparation steps of covering floors and furniture may avoid messes from spilling such colorants. This assists in avoiding a difficult cleaning dilemma if a spill occurs. Of course, if the amount of colorant is not pre-dosed the possibility of obtaining another container of coating composition of the same color is reduced.

Recently readily dispersible pigment granules, such as those available from BASF and available as “Xfast stirred-in pigments allow for addition to waterborne paints without dispersion of the pigments in a bead mill. Such pigments reportedly are quickly, evenly, and immediately dispersed to develop full tinting strength simply by stirring into or shaking into the white paint. These free-flowing, low-dusting, easily-handled and rapidly dispersing micro-granules are made by using an additive system to coat pre-dispersed pigment particles. When added to water based paints these pigment particles disperse without forming large pigment aggregates thus enabling direct coloration with stir-in pigments. These pigments can be added in manufacturing plant operations or at the point-of-use. Such pigment granules are typically used as dry single pigment tinters. For instance, a range of 20 pigments covering 17 different color types covers the color space needed for use in decorative paints and wood stains. This range of colors can be produced by mixing together several single pigment tinters into the coating composition.

However, there still exists a need for further improving the performance of dry tinters since these can spill just like liquid tinters when they are poured from a container or sachet. Even though the dry tinters allow for easier removal of all of the tinter from the container compared to liquid tinters, spilled dry tinters can be difficult to clean or remove since they can spread when wiped with a damp cloth. In particular, there is a need for further improving the performance of the addition of dry tinters to water based or borne coating compositions to minimize the risk of spilling the tinter in a location other that in the coating composition. Such spilling not only results in leaning difficulties but affects the reproduction of the exact color that could have been obtained if all of the dry tinter was added to the coating composition.

Also there is a need for expanding the range of colors available for a ready mix type of coating product without the necessity of occupying a lot of shelf space at a retail outlet to accommodate the number of containers of coating compositions for the expanded range of colors. Consolidating the shelf space required while expanding the range of colors that are easily or readily mixable expands the possible colors available for use by the purchaser. Such a readily mixable product can be selected by the consumer for use without much attention by the personnel of the retail establishment.

Although the present invention may obviate one or more of the above-mentioned problems, it should be understood that some aspects of the invention might not necessarily obviate one or more of those problems or fulfill one or more of the afore-mentioned needs.

In the following description, certain aspects and embodiments will become evident. It should be understood that the invention, in its broadest sense, could be practiced without having one or more features of these aspects and embodiments. It should be understood that these aspects and embodiments are merely exemplary.

### SUMMARY OF THE DISCLOSURE

In one aspect, as embodied and broadly described herein, the present invention may include an article of manufacture comprising at least one water dispersible tinting material encapsulated in a polymeric layer that has solubility in water. The tinting material is releasable into a water based coating composition to give the coating composition color. The polymeric layer can have one or more polymeric films where the at least one polymer has solubility in an aqueous containing medium, when the layer has a thickness about 0.5 to about 5 mils to dissolve in order to release the dispersible tinting material into an aqueous containing coating composition. Such a coating composition can have about at least 20 volume percent solids, and at least about 45 volume percent water into which the tinting material disperses and the polymeric encapsulating dissolves or disintegrates in less than 20 minutes with at least continuous hand agitation at a temperature in the range of about 50 to about 110° F. The dissolution of the at least one polymer of the layer also allows for disintegration and dissolution into the aqueous medium.

According to another aspect of the invention, the encapsulating layer is in the form of a sealed pouch that contains the tinting material. At least one of the sealed pouches can be present in a moisture resistant package or container. The moisture resistant package or container can reduce the moisture encountered by the at least one pouch prior to adding a pouch to the water based coating composition for dissolving of the pouch encapsulating layer and for providing of tinting material to color the composition.

It is also another aspect of the present invention to provide a plurality of the pouches as a kit or system, where different pouches have different tinting materials, for example different in kind and/or concentration, to provide a variety of color choices for addition to the water-based or water borne coating compositions. In one aspect of the invention, there can be enough pouches to provide a color range of even up to about 150 different colors and/or shades.

In another aspect of the present invention a kit or system can include one or more of the moisture resistant packages having a plurality of pouches to provide a range of shades for a particular color hue. In such an aspect the range of monochromatic shades can range from a light shade and/or to a medium and/or to a darker shade. A nonexclusive instance would be to have three pouches in the moisture resistant package, where the pouches provide a range of monochromatic shades from a light to a medium and to a deeper shade. Such an example would be a first pouch having an effective amount of tinting material for a light shade of pink, a second pouch, which can have an effective amount of tinting material for a medium shade of pink, and a third pouch having an effective amount of tinting material for a deeper shade of pink.

In another aspect of the present disclosure a method is provided for tinting a water-based coating composition without the need for elaborate tinting equipment, and even where the tinting can be performed conveniently close to the location of use of the coating composition. Such a method can involve having a kit with a specific volume of water-based coating composition in a container having sufficient headspace to allow for hand agitation with a stirrer along with one or more moisture resistant packages, which can comprise one or more water-soluble pouches of tinting material. The at least one water resistant pack is opened, and at least one pouch is selected. If a plurality of pouches is present then a pouch having an effective amount of tinting material to provide a lighter shade of color to the coating composition can be selected. The pouch can be deposited in the container having unpigmented or tint base coating composition where the container has headspace to allow for some splashing of the coating when hand stirring is performed with a wooden stirrer. The coating composition with the deposited pouch at room temperature or even an outdoor temperature in the range of about 50 to about 100° F. or more allows for the polymeric layer of the pouch to begin to dissolve and release the dispersible tinting material. On continuation of stirring or agitation by hand, or with an electric drill with an attached rotatable stirrer or even a conventional retail paint shaker device a majority if not all of the pre-dosed tinting material is released into the coating composition. With continuous stirring or shaking this tinting material is distributed into the coating composition to give the composition a color or a different color. A non-exclusive suitable container of coating composition may be a 1 gallon volume or slightly less than one gallon up to even 5 gallon amount of coating composition in a slightly larger container. For slightly less than one gallon of paint the container can have sufficient headspace to provide for the hand agitation to distribute the tinting material in the composition at 1.4 or 1.5 gallon size container.

The above summary of the present invention is not intended to describe each disclosed embodiment or every implementation of the present invention. The description that follows more particularly exemplifies illustrative embodiments. In several places throughout the application, guidance is provided through lists of examples which examples can be used in various combinations. In each instance, the recited list serves only as a representative group and should not be interpreted as an exclusive list.

### BRIEF DESCRIPTION OF THE DRAWINGS

The accompanying drawings, which are incorporated in and constitute a part of this specification, illustrate a number of non-limiting embodiments of the invention and together with the description, serve to explain the principles of the invention.

FIG. 1 is a front elevational view of a moisture resistant package shown diagrammatically comprising a pouch with a bottom cut away view to depict the tinting material in the pouch according to one embodiment of the invention.

FIG. 2 is a cross-sectional view from the end of a moisture resistant package to show the contents of a plurality of pouches.

FIG. 3 is a perspective view of plurality of moisture resistant packages which may have the pouches of FIG. 1 and/or 2 vertically disposed in a tray as a kit.

FIG. 4 is a plan view of a sheet showing the light, medium and deep shades of color that can be pre-dosed into the tinter material where each shade dosage would be a separate pouch and three pouches could be packaged in one moisture resistant pack.

FIG. 5 is a plan view of the wide array of colors possible with a system of pouches where a range of three progressively deeper shades are provided one shade per pouch.

Reference will now be made in detail to exemplary embodiments of the invention, examples of which are illustrated in the accompanying drawings. Wherever possible, the same reference numbers will be used throughout the drawings and the description to refer to the same or like parts. It is to be understood that both the foregoing general description and the following detailed description are exemplary and explanatory only and are not restrictive of the invention, as claimed.

### DETAILED DESCRIPTION OF EMBODIMENTS OF THE PRESENT INVENTION

As used in the afore-discussed embodiments and other embodiments of the invention described herein the following terms generally have the meaning as indicated but these meaning are not meant to limit the scope of the invention if the benefit of the invention is achieved by inferring a broader meaning to the following terms.

The term “water-dispersible” when applied to the one or more polymers in the encapsulating layer generally refers to a polymeric film that is itself capable of being dispersed into available water of water based or water borne coating composition (i.e., without requiring the use of a separate surfactant) so that the film is undetectable to the unaided human eye when the coating is applied as a wet film to a substrate.

The term “waterborne coating composition” is understood to mean conventional water-borne coating compositions, materials, and formulations that have no compressed fluid admixed therewith. Such coating compositions are generally comprised of a nonvolatile materials fraction comprising at least one polymer component that is capable of forming a coating film on a substrate, whether such component is a paint, enamel, lacquer, varnish, adhesive, chemical agent, release agent, lubricant, protective oil, caulk, an agricultural coating, or the like. The water-borne coating compositions, in addition to the nonvolatile materials fraction, also contain a carrier or solvent fraction which is typically at least partially miscible with the nonvolatile materials fraction. As used herein, the phrase “nonvolatile materials” is understood to mean solid materials and liquid materials such as solid polymers, liquid polymers, and other compounds that are nonvolatile at a temperature of about 25° Celsius. In general, the nonvolatile materials fraction is the portion of the water-borne coating composition that remains after the carrier or solvent fraction has been removed usually through evaporation. As used herein, it will be understood that the term “water-borne coating composition” includes not only coating compositions used to form protective or decorative coatings but can also include adhesives, caulks, release agents, lubricants, agricultural materials, and the like, which are capable of being sprayed to deposit a coating on a substrate. In other words these can be coating compositions in which the polymeric binder is a dispersion of insoluble polymer in water. Waterborne paints can be referred to as emulsion paints' and these represent the most common type of wall and ceiling paints now in use. Emulsion paints first were developed in the 1950's. Also waterborne coatings can be predominantly liquid and generally can be prepared from liquid blended raw materials, such as titanium dioxide slurries, extender pigment slurries, thickener slurries, glycol slurries, and latex binders. The liquid blends have substantially the same viscosity characteristics as the final waterborne coating composition, in the range of about 70 to about 125 Krebs units, Emulsion paints comprise a film-forming polymer which is insoluble in water and which is in the form of a colloidal dispersion (sometimes called an “emulsion” or a “latex”). They also comprise one or more particulate non-film forming solids which can be pigments, such as titanium dioxide, or extenders such as powdered chalk. The paints usually also comprise a thickener.

The term “latex” for a coating composition means the primary film forming polymeric components of the composition or paint are those that are capable of being dispersed in water by themselves or through the use of one or more secondary emulsifying agents (e.g. at least one surfactant) for creating an emulsion of polymer particles in water.

The terms “substance”, “coloring materials” and the term “tinting material” are used interchangeably herein to refer to the ingredient intended for delivery, i.e., the film or layered pouch serves as the vehicle for delivery of the tinting material into the coating composition like the water borne coating composition.

The term “substantially aqueous medium” means the environment wherein the polymeric film or layer or pouch dissolves, releasing the substance. Typically, the substantially aqueous medium will be within a water based or water borne coating composition, a non-exclusive example of which is a latex paint or stain. It is to be understood that both the film and tinting material may disperse in the aqueous environment, or the film, encapsulating material may dissolve and tinting material or at least the one or more pigments in the tinting material may disperse or dissolve into the aqueous environment.

The word “pigment” is of Latin origin (pigmentum) and originally denoted a color in the sense of a coloring matter, but was later extended to indicate colored decoration (e.g., makeup). The modern meaning associated with the word pigment means a substance composed of small particles that is practically insoluble in the applied medium and is used on account of its coloring, protective, or magnetic properties. Both pigments and dyes are included in the general term “coloring materials” or “tinting materials”, which denote all materials used for their coloring properties. The characteristic that distinguishes pigments from soluble organic dyes is their low solubility in solvents and binders. Pigments can be characterized by their chemical composition, and by their optical or technical properties. In the Color Index (C.I.) pigments are usually named “C.I. Pigment XY xy”, Some compounds may be named “C.I. Solvent XY xy” due to their migration tendency in polymer application, although in water or organic solvents these compounds may fulfill the insolubility criteria for pigments. Pigments can be classified into two general categories of, (i) inorganic pigments, and (ii) organic pigments.

The terms, “climatic water conditions” are intended to refer to an environment where there is sufficient water to dissolve the film, i.e. the concentration of film polymer does not exceed its solubility limit in available water of a composition where the temperature of the water can be at a temperature of applying a coating composition to a substrate whether inside a structure or in the external climatic environment and more suitably at a temperature in the range of about 35° F. to about 105° F. It is anticipated that the improvements in dissolution achieved with the films and articles of the present invention will likely be seen under warm and hot water conditions as well.

The terms, “rapidly dissolving” are intended to refer to the disintegration and subsequent dissolution of the polymer film in less than about 15 minutes, more suitably less than about 7 minutes and even more suitably less than about 3 minutes after the film or an article made therefrom is placed in water at a temperature in the range of about 35° F. to 105° F. conditions.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements. Unless stated otherwise, all percentages, ratios and proportions herein are by weight and particularly unless otherwise specified stated the proportions of the components in the compositions described are given in percentage pertaining to the total mass of the mixture of these components.

Also herein, the recitations of numerical ranges by endpoints include all numbers subsumed within that range (e.g., 1 to 5 includes 1, 1.5, 2, 2.75, 3.80, 4, 5, etc.).

Also herein, “a,” “an,” “the”, “at least one,” and “one or more” are used interchangeably.

Also herein, the terms “comprises” and variations thereof do not have a limiting meaning where these terms appear in the description and claims.

All temperatures are in degrees Fahrenheit (° F.) unless otherwise specified.

All documents cited are incorporated herein by reference in their entireties. Citation of any reference is not an admission regarding any determination as to its availability as prior art to the claimed invention.

Suitable water soluble films at climatic conditions of use of waterborne coating compositions include those like the water-soluble films described in U.S. Pat. No. 3,322,674 that are internally coated with a wax or other material to prevent the contents of the package from interacting with the film material and degrading its solubility characteristics; and films made of plasticized polyvinyl alcohol compositions as shown in U.S. Pat. No. 3,413,229, and/or cold water soluble films that comprises a combination of polymers having different molecular weights with the lowest molecular weight polymer of about 21,000 as described in U.S. Pat. No. 3,892,905, and/or films of low molecular weight polyvinyl alcohol compositions and a medium molecular weight PVA, where the “low” and “medium” molecular weights are in terms of the viscosity of a solution containing the polymer as shown in U.S. Pat. No. 4,119,604; water-soluble films of polyvinyl alcohol and polyvinyl pyrrolidone that are cold water soluble for packaging various products as shown in U.S. Pat. No. 4,481,326, where the film comprises hydrolyzed polyvinylacetate alcohol and polyvinyl pyrrolidone; water-soluble film composed of polyvinyl alcohol, polyvinyl pyrrolidone, ethoxylated alkyphenol, and polyhydric alcohol that reportedly dissolves in water as cold as 5° C. in U.S. Pat. No. 4,544,693; water-soluble films of polyvinyl alcohol blended with polyacrylic acid for a cold water soluble film as shown in U.S. Pat. No. 4,692,494; water-soluble laminate film that comprises at least one methylcellulose layer of hydroxybutyl methylcellulose (HBMC) blended with hydroxypropyl methylcellulose (HPMC) and at least one layer of polyvinyl alcohol incorporating a cross-linking agent, where the solubility of the laminate is pH rather than temperature dependent as shown in U.S. Pat. No. 4,765,916.

Other suitable film-forming compositions for use in preparing water-soluble polymer-containing films that are rapidly dissolving under climatic water conditions can include one or more water soluble polymer materials such as polyvinyl alcohol with a principal solvent, typically diol(s) or derivative of a diol. Any water-soluble, film-forming polymer or mixtures of polymers, may be used in such film-forming compositions. The polymers usually are vinyl polymers, including homopolymers and copolymers, having functionality rendering the polymers water-soluble, such as hydroxyl and carboxyl groups. Typical water-soluble polymers include at least one of polyvinyl alcohol, partially hydrolyzed polyvinyl acetate, polyvinyl pyrrolidone, alkyl celluloses such as methylcellulose, ethylcellulose, propylcellulose and derivatives thereof, such as the ethers and esters of alkyl celluloses, and acrylic polymers such as water-soluble polyacrylates, polyacrylamides, and acrylic maleic anhydride copolymers. Suitable water-soluble polymers further include copolymers of hydrolyzed vinyl alcohol and a nonhydrolyzable anionic comonomer, such as described in U.S. Pat. No. 4,747,966 to Yang et al.

It will be evident that a wide variety of film-forming water-soluble polymer materials, including synthetic and natural polymers, and mixtures thereof, as described in standard textbooks on the subject and in the patent literature may be used to advantage. For example, in addition to the U.S. patents cited above, Japanese unexamined patent applications JP 01317506A published Dec. 22, 1989, and JP 60061504A published Apr. 9, 1985, describe water-soluble films of polyvinyl alcohol, polyvinyl pyrrolidone, methylcellulose, cellulose acetate, polyethylene oxide, gelatin, partially saponified polyvinyl alcohol, CMC, dextrin, starch, hydroxyethyl cellulose, agar, pectin, and others for the packaging of process chemicals such as sodium sulfate and solid agricultural chemicals. Similarly, British Patent 2,191,379 granted Dec. 16, 1987, describes the packaging of animal feed supplements in a plastic film of polyvinyl alcohol, polyvinyl acetate, ethylene/vinyl acetate copolymer or an alkylcellulose ester. The disclosures of all of the above cited patents and patent applications are incorporated herein by reference.

Particularly suitable film-forming polymers are polyvinyl alcohol, vinyl alcohol/vinyl acetate copolymers, polyvinyl pyrrolidone, gelatin, and mixtures of any of the foregoing. Polymer films comprising polyvinyl alcohol can be prepared that are rapidly dissolvable even at colder temperatures i.e. less than about 50° F. or less than about 40° F. can be used. Further, polyvinyl alcohols having varying average molecular weights (i.e. mean weights of the molar masses) such as from about 6,000 to about 78,000 or higher may be used. Likewise, polyvinyl alcohol having varying degrees of hydrolysis may also be used to advantage. Suitably, such polymers can be less than about 90%, more suitably less than about 85%, and still more suitably less than about 80% hydrolyzed, but will be more than about 60% and more suitably at least about 70% hydrolyzed. Blends of water-soluble polymers having different degrees of hydrolysis may also be used to advantage. Other suitable film-forming polymers include polyethylene oxide, polyvinyl pyrrolidone, hydroxypropyl methylcellulose and hydroxyethylcellulose.

Blends of water-soluble film-forming polymers may also be used to advantage. Blends offer additional advantages in that rapidly dissolving films can be produced with good mechanical properties for subsequent handling and converting into manufactured articles. For instance, a blend containing at least two types of water-soluble polymers that have disparate molecular weights, can be used to prepare film that is rapidly dissolving even under cold water conditions. For instance, such blends can contain at least one type of polymer that has a molecular weight greater than about 50,000, suitably greater than about 60,000 and even more suitably greater than about 70,000, and a second polymer or mixture of polymers having an average molecular weight of less than about 30,000, more suitably less than about 15,000, and even more suitably less than about 10,000.

In addition, blends of different types of polymer materials can also be formulated and prepared to produce the films for the present invention. For instance, ratios such as 80/20, 60/40 and 50/50 with mixes of polyvinyl alcohol and polyvinyl pyrrolidone, polyvinyl alcohol and polyethylene oxide, polyvinyl alcohol and hydroxyethyl cellulose, polyvinyl pyrrolidone and hydroxyethyl cellulose, polyvinyl pyrrolidone and polyethylene oxide, and polyethylene oxide and hydroxyethyl cellulose, hydroxypropyl methylcellulose and polyvinyl alcohol, can be used to advantage.

A blend can be used of at least one polyvinyl alcohol having a molecular weight of about 78,000 and higher and a second polyvinyl alcohol about 6,000 or lower to achieve a rapidly dissolving firm under cold water conditions. Adequate strength of the film for encapsulating at least one pigment can be from a low percentage of a higher molecular weight polyvinyl alcohol, around, less than about 50% more suitably less than about 40%, and even more suitably less than about 30%. A higher percentage of higher molecular weight polyvinyl alcohol, namely, greater than about 50%, suitably greater than about 60% and more suitably greater than about 70%, can provide the improved strength and elasticity that is desired for vacuum forming operations, but it should be noted that such higher percentages of high MW polymers are typically accompanied by increasingly higher dissolution times. Blends of high and low molecular weight polymers at ratios of 80/20, 60/40, and 50/50 mixtures of low to high molecular weight polyvinyl alcohol can be evaluated for specific applications.

Also a rapidly dissolving film can be prepared from a blend of polyvinyl alcohol that comprises from about 60% to about 95% of polyvinyl alcohol of an average molecular weight from about 3,000 to about 30,000 and from about 5% to about 40% of polyvinyl alcohol of an average molecular weight from about 30,000 to about 200,000. The degree of hydrolysis in the polyvinyl alcohol blend is less than about 90 mol %, more suitably less than about 85% mol %, and still more suitably less than about 80 mol %. The film formed from aforementioned compositions can be used with or without a major solvent.

The film forming compositions can also comprise less than about 50%, such as from about 5% to about 35%, more suitably from about 8% to about 25%, and even more suitably from about 10% to about 20%, of a predominant solvent, by weight of the composition. Said principal solvent can be selected to minimize the time required for the water-soluble film to disintegrate and dissolve under cold water conditions, Dissolution data on films with and without a principal solvent can be obtained from standard “Solubility Test Methods.” Non-exclusive examples of suitable principal solvents include alcohols, and in particular polyols such as diols. Specific non-limiting examples of suitable principal solvents include 1,4-butanediol, 1,3 butanediol and 1,2-hexanediol, 2,2,4-trimethylpentanediol, ethoxylates of 2,2,4-trimethylpentanediol, 2-ethyl 1,3 hexanediol, and 1,4 cyclohexanedimethanol, and 1,2 cyclohexanedimethanol. For molecules exhibiting isomerism, both the trans and cis forms can function as principal solvents. Additional non-exclusive examples of suitable solvents can also include low molecular weight alcohols, polyols, alcohol ethoxylates and the like. In addition, hydrotropes such as sodium toluene sulfonate, sodium butyrate, sodium cumene sulfonate, sodium xylene sulfonate, and other hydrotropic materials can also be used to improve the cold water solubility of the film composition.

Optionally, the film-forming compositions may contain a variety of adjunct ingredients that are well known to those in the film-forming art. Each of these components can be varied according to the levels desired in a given cold water soluble film.

Another non-exclusive example of a suitable water soluble polymeric material are pyrodextrins which are substantially 100% soluble in water, and substantially hydratable in a solution which has low free water, at ambient temperature, have high viscosities relative to a canary dexrin and are solution stable. These dextrins are prepared by preferably acidifying the starch, and dextrinizing under substantially anhydrous conditions for a time and at a temperature sufficient to result in the desired end product as described in U.S. Pat. No. 6,191,116 hereby incorporated in its entirety by reference.

Other suitable water soluble polymers include, but are not limited to pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein and various mixtures thereof.

The film may be made by a variety of processes known in the art. For example, the starch may be dispersed with the other film components in water or other solvent and dried into firm form. In the alternative, the starch and other dry components may be blended and then dispersed with any additional film components in water or other solvent and dried into film form. Films may be formed from such dispersions or solutions by shaping it into a solidified form of a suitable thickness by any technique known in the art including, but not limited to, wet casting, freeze-drying, and extrusion molding.

A particularly suitable process for preparing the films is by preparing a coating formulation by making a solution or dispersion of the film components, applying the mixture to a substrate, using knife, bar or extrusion die coating methods, drying the coated substrate to remove the majority of the solvent, and removing the film from the substrate. Suitable substrates include, but are not limited to, silicone elastomers, metal foils and metalized polyfoils, composite foils or films containing polyetrafluoroethylene materials or equivalents thereof, polyether block amide copolymers, polyurethanes, polyvinylidene chloride, nylon, polyethylene, polyester, and other such materials useful in the art as releasable substrates.

The film is not completely dried in that some degree of water or other solvent remains. The amount of water may be controlled to obtain desired functionality. For example, more water typically results in a more flexible film, while too much water results in a film that will block and be tacky.

The film thickness may typically be in the range of about 0.5 to about 5 mils or 1 to 500 microns, particularly 25 to 100 microns especially if the film has an embossed pattern on imprinted on it giving areas of decreased thickness. For a suitable film thickness to form a layer of a pouch for hand agitation into latex paint for quick dissolution without visual appearance of any undissolved remnants, the film thickness is more preferably from about 25 to 50 microns. Thicker films may be use in higher viscosity coating compositions or the like.

The films can be wetted when exposed to water, such as when placed in a water borne coating composition or other substrate surface, followed by rapid dissolution and/or disintegration. The wettability and dissolution rates of the starches may be modified by one skilled in the art to target a specific delivery profile.

Suitable aqueous soluble polymeric films include those specialty water soluble polyvinyl alcohol (PVOH) based films like M-3030, available from MonoSol LLC, of Indiana which can be used even with slightly alkaline coating compositions. Such a film at a thickness in the range of 0.5 to 3 mils can handle premeasured unit doses of powered water dispersible pigments. If one or both major opposing surfaces of the film are embossed to give the film thinner portions the general average thickness of the film can be slightly thicker to even 5 mils. Such films encapsulating the pigment powders offer a multitude of benefits in providing the end-user with pre-packaged, pre-measured unit doses for coloring coating compositions where the risk of direct contact with the pigments has been reduced. The M-3030 film is available from MonoSol in thicknesses ranging from 1 to 2.0 mil and in widths up to 54 inches.

Water soluble films from the polymers and materials listed above can be formed into pouches or packets by having two sheets of the films placed opposite each other and heat sealed around the perimeter of at least three sides to form a pocket or pouch into which the dispersible pigment materials can be placed. Films made from the aforelisted film-forming compositions when formed into packets or pouches or the like may have a seam where the two or more layers or pieces of film are joined. If the seam, which would be around double the thickness of the thickness of the film, is outside the range of thickness for the film the seam can be embossed to reduce portions of its thickness to assist in dissolving the pouch. Such pouches can be filled in any way known to those skilled in the art of filling pouches with granular or liquid material so that the pouch can encapsulate colorant materials like one or more pigments that are dispersible in aqueous medium such as water based or water borne coating composition.

Suitable water dispersible colorant materials or tinting materials can include: liquid or particulate or granular pigments which can be combined with other materials such as a nonionic surface-active additive. The colorant materials can be free of thickeners, such as cellulose ethers, and film formers, such as polyvinyl acetates and alcohols. The average particle size of the pigment granules can be in the range from 50 to 5000 .mu.m, and especially in the range from 100 to 1000 .mu.m. The BET surface area of the pigment granules can be .Itoreq.15 m.sup.2/g, and preferably .Itoreq.10 m.sup.2/g.

Suitable pigment granules may be an organic pigment or an inorganic pigment. It will be appreciated that the pigment granules may also include mixtures of various organic or various inorganic pigments or mixtures of organic and inorganic pigments. The pigments can be present in finely divided form. Accordingly the pigments typically have average particle sizes from 0.1 to 5. mu.m. The organic pigments are typically organic chromatic, white and black pigments (color pigments). Inorganic pigments can likewise be color pigments and also luster pigments and the inorganic pigments typically used as filters. The term “pigments” should be understood as meaning white or colored, inorganic or organic particles of any shape which are insoluble in the physiological medium and which are intended to color the composition. The pigments can be white or colored and inorganic and/or organic. Among organic pigments that may be used according to the present disclosure, non-limiting mention may be made of titanium dioxide, optionally surface treated, zirconium or cerium oxides, as well as zinc, (black, yellow or red) iron or chromium oxides, manganese violet, ultramarine blue, chromium hydrate and ferric blue, or metal powders, such as aluminium powder or copper powder. Among organic pigments that may be used according to the present disclosure, further non-limiting mention may be made of carbon black, pigments of D & C type and lakes based on cochineal carmine and on barium, strontium, calcium or aluminium.

Suitable non-exclusive examples of suitable organic color pigments include, monoazo pigments: C.I. Pigment Brown 25; C.I. Pigment Orange 5, 13, 36, 38, 64 and 67; [0024] C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146. 14:8, 170, 175, 184, 185, 187, 191:1, 208, 210, 245, 247 and 251; C.I. Pigment Yellow 1, 3, 62, 65, 73, 74, 97, 120, 151, 154, 168, 181, 183 and 191; C.I. Pigment Violet 32; disazo pigments: C.I. Pigment Orange 16, 34, 44 and 72; C.I. Pigment Yellow 12, 13, 14, 16, 17, 81, 83, 106, 113, 126, 127, 155, 174, 176 and 188; disazo condensation C.I. Pigment Yellow 93, 95 and 128; pigments, C.I. Pigment Red 144, 166, 214, 220, 221, 242 and 262; C.I. Pigment Brown 23 and 41: anthanthrone pigments: C.I. Pigment Red 168; anthraquinone pigments: C.I. Pigment Yellow 147, 177 and 199; C.I. Pigment Violet 31; anthrapyrimidine; pigments: C.I. Pigment Yellow 108; quinacridone pigments: C.I. Pigment Orange 48 and 49; 0.1. Pigment Red 122, 202, 206 and 209; C.I. Pigment Violet 19, quinophthalone pigments: C.I. Pigment Yellow 138; diketopyrrolopyrrole pigments: C.I. Pigment Orange 71, 73 and 81; C.I. Pigment Red 254, 255, 264, 270 and 272; dioxazine pigments: C.I. Pigment Violet 23 and 37; C.I. Pigment Blue 80; flavanthrone pigments: C.I. Pigment Yellow 24; indanthrone pigments: C.I. Pigment Blue 60 and 64; isoindoline pigments: C.I. Pigments Orange 61 and 69; C.I. Pigment Red 260; C.I. Pigment Yellow 139 and 185; isoindolinone pigments: C.I. Pigment Yellow 109, 110 and 173; isoviolanthrone pigments: C.I. Pigment Violet 31; metal complex pigments: C.I. Pigment Red 257; C.I. Pigment Yellow 117, 129, 150, 153 and 177; C.I. Pigment Green 8; perinone pigments: C.I. Pigment Orange 43; C.I. Pigment Red 194, perylene pigments: C.I. Pigment Black 31 and 32; C.I. Pigment Red 123, 149, 178, 179, 190 and 224; C.I. Pigment Violet 29; phthalocyanine pigments: C.I. Pigment Blue 15, 15:1, 15:2, 15:3, 15:4, 15:6 and 16; C.I. Pigment Green 7 and 36; pyranthrone pigments, C.I. Pigment Orange 51; C.I. Pigment Red 216; pyrazoloquinazolone; pigments: C.I. Pigment Orange 67; C.I. Pigment Red 251; thioindigo pigments: C.I. Pigment Red 88 and 181; C.I. Pigment Violet 38; triarylcarbonium; pigments: C.I. Pigment Blue 1, 61 and 62; C.I. Pigment Green 1; 0.1. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22. Examples of suitable inorganic color pigments are: white pigments: titanium dioxide (C.I. Pigment White 6), zinc white, pigment grade zinc oxide; zinc sulfide, lithopone; black pigments: iron oxide black (C.I. Pigment Black 11), iron manganese black, spinel black (C.I. Pigment Black 27); carbon black (C.I. Pigment Black 7); chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue, ultramarine violet; cobalt violet: manganese violet; red iron oxide (C.I. Pigment Red 101); cadmium sulfoselenide (C.I. Pigment Red 108); cerium sulfide (C.I. Pigment Red 265); molybdate red (C.I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange; cerium sulfide (C.I. Pigment Orange 75); yellow iron oxide (C.I. Pigment Yellow 42); nickel titanium yellow (C.I. Pigment Yellow 53: C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184). Examples of inorganic pigments typically used as fillers are transparent silicon dioxide, ground quartz, aluminum oxide, aluminum hydroxide, zinc sulfide, natural micas, natural and precipitated chalk and barium sulfate. Luster pigments are platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

In addition the tinting material granules can have at least one nonionic surface-active additive based on polyethers such as unmixed polyalkylene oxides like polyethylene oxides and polypropylene oxides, or alkylene oxide block copolymers. Also copolymers comprising polypropylene oxide and polyethylene oxide blocks are suitable. They, like the unmixed polyalkylene oxides, can be obtained by polyaddition of these alkylene oxides to saturated or unsaturated aliphatic and aromatic alcohols and aliphatic amines, in which case these starter compounds are reacted with ethylene oxide first and then with propylene oxide or preferably with propylene oxide first and then with ethylene oxide as is well known in the art.

Suitable aliphatic alcohols generally contain from 6 to 26 carbon atoms, preferably from 8 to 18 carbon atoms. Examples are octanol, nonanol, decanol, isodecanol, undecanol, dodecanol, 2-butyloctanol, tridecanol, isotridecanol, tetradecanol, pentadecanol, hexadecanol, 2-hexyldecanol, heptacdecanol, octadecanol, 2-heptylundecanol, 2-octyldecanol, 2-nonyltridecanol, 2-decyltetradecanol, oleyl alcohol and 9-octadecenol and also mixtures of these alcohols such as C.sub.13/C.sub.15 and C.sub.16/.sub.18 alcohols. Of particular interest are the fatty alcohols obtained from natural raw materials by fat hydrolysis and reduction and the synthetic fatty alcohols from the oxo process. The alkylene oxide adducts with these alcohols typically have average molecular weights Mn (number average molecular weight) from 400 to 2000.

Useful aromatic alcohols, besides .alpha.- and .beta.-naphthol and C1-C4-alkyl (having one to four carbons) derivatives thereof, include in particular phenol and its C1-C12-alkyl derivatives, such as hexylphenol, heptylphenol, octylphenol, nonylphenol, isononylphenol, undecylphenol, dodecylphenol, di- and tributylphenol and dinonylphenol. Useful aliphatic amines correspond to the above-recited aliphatic alcohols and the alkylene oxide adducts with these monofunctional amines and alcohols and the alkylene oxide adducts with at least bifunctional amines and alcohols. The at least bifunctional amines preferably have from two to five amine groups and conform in particular to the formula H₂N—(R—NR₁)ₙ—H(R: C2-C6-alkylene: R¹ hydrogen or C1-C6-alkyl, n: 1 to 5). Specific examples are; ethylenediamine, diethylenetriamine, triethylenetetramine, tetraethylenepentamine, 1,3-propylenediamine, dipropylenetriamine, 3-amino-1-ethyleneaminopropane, hexamethylenediamine, dihexamethylenetriamine, 1,6-bis(3-aminopropylamino)hexane and N-methyldipropylenetriamine, of which hexamethylenediamine and diethylenetriamine are more preferable and ethylenediamine is suitable. These amines can be reacted first with propylene oxide and then with ethylene oxide. The ethylene oxide content of the block copolymers is typically about 10-90% by weight The block copolymers based on polyamines generally have average molecular weights Mn from 1000 to 40000 and preferably from 1500 to 30000.

The at least bifunctional alcohols can have from two to five hydroxyl groups. Examples are C2-C6-alkylene glycols and the corresponding di- and polyalkylene glycols, such as ethylene glycol 1,2-propylene glycol, 1,3-propylene glycol, 1,2-butylene glycol, 1,4-butylene glycol, 16-hexylene glycol, dipropylene glycol and polyethylene glycol, glycerol and pentaerythritol, of which ethylene glycol and polyethylene glycol are suitable and propylene glycol and dipropylene glycol are more suitable.

Particularly suitable alkylene oxide adducts with at least bifunctional alcohols have a central polypropylene oxide block, ie are based on a propylene glycol or polypropylene glycol which is initially reacted with further propylene oxide and then with ethylene oxide. The ethylene oxide content of the block copolymers is typically in the range from 10 to 90% by weight.

The block copolymers based on polyhydric alcohols generally can have average molecular weights M n from 1000 to 20000 and preferably from 1000 to 15000. Such alkylene oxide block copolymers are known and commercially available, for example under the names Tetronic® and Pluronic® (BASF). Alkylene oxide block copolymers (B) are selected with different hydrophilic-lipophilic balance (HLB) values, depending on the application medium in which the pigment granules of the present invention are to be used. For use in aqueous, aqueous/alcoholic and alcoholic systems, preference is given to alkylene oxide block copolymers (B) having HLB values of about a gtoreq.10, which corresponds to an ethylene oxide content of the copolymers of generally .gtoreq.2 25% by weight.

For use of the pigment granules of the present invention in hydrocarbonaceous, eg mineral oil containing or xylenic systems or systems based on nitrocellulose, alkylene oxide block copolymers (B) having HLB values of about <10 are particularly suitable, this HLB value corresponding to an ethylene oxide content of the copolymers of generally <25% by weight. The pigment granules of the present invention can include from 60 to 90% by weight and preferably from 70 to 85% by weight of component (A) and from 10 to 40% by weight and preferably from 10 to 30% by weight of component (B), They are advantageously obtainable by the process of the invention by wet-comminuting the pigment (A) in aqueous suspension in the presence of some or all of the nonionic additive (B) and then spray granulating the suspension, if applicable after the rest of additive (B) has been added. Pigment (A) can be used in the process of the present invention as a dry powder or in the form of a presscake. Pigment (A) as used is a finished product, ie the primary particle size of the pigment has already been adjusted to the desired application value. This finish is necessary in the case 5 of organic pigments especially, since the as-synthesized crude material is not suitable for use. In the case of inorganic pigments, for example in the case of oxide and bismuth vanadate pigments, the primary particle size may also be adjusted in the course of the synthesis of the pigment, so that the as-synthesized pigment suspensions can be used direct in the process of the present invention. Since the finished pigment (A) typically reagglomerates in the course of drying or on the filter assembly, it is subjected to wet comminution, for example grinding in a stirred media mill, in aqueous suspension. The wet comminution can be performed in the presence of at least a portion of the additive (B) for the ready-produced pigment granules, and it is preferable to add the entire amount of additive (B) prior to the wet comminution. Spray granulation is suitably performed in a spray tower using a one-material nozzle. Here, the suspension is sprayed in the form of relatively large drops, and the water evaporates. Additive (B) melts at the drying temperatures and so leads to the formation of a substantially spherical granule having a particularly smooth surface. The gas inlet temperature in the spray tower is generally in the range from 180 to 300.degree. C. and preferably in the range from 150 to 300.degree. C. The gas outlet temperature is generally in the range from 70 to 150.degree. C. and preferably in the range from 70 to 130.degree. C. The residual moisture content of the granular pigment obtained is generally <2% by weight.

The pigment granules for use in the tinting material useful in the present invention are notable in use for their color properties which are comparable to those of liquid pigment formulations, especially with regard to color strength, brilliance, hue and hiding power, and especially for their stir-in characteristics, ie they can be dispersed in application media with a minimal input of energy, simply by stirring or shaking.

Compared with liquid pigment formulations, which can also be used with the appropriate polymeric film layer of the encapsulant, the pigment granules have a higher pigment content. The liquid formulations tend to change viscosity in the course of storage, and have to be admixed with preservatives and agents for enhancing the resistance to freezing and/or drying out, the pigment granules useful in the present invention exhibit very good stability in storage.

The pigment granules useful with the present invention can have good attrition resistance, a minimal tendency to compact or clump, uniform particle size distribution, good pourability, flowability and meterability, and also dustlessness in handling and application.

When the HLB value of the additive (B) included in the pigment granules of the present invention has not been adapted to the character of the application medium, as described above, the granules can initially be stirred into a solvent which is compatible with the particular application medium, and this stirring into the solvent is again possible with minimal input of energy, and then be introduced into this application medium. For instance, slurries of pigment granules having high HLB values in glycols or other solvents customary in the paint and coatings industry, such as methoxypropyl acetate, can be used to render the pigment granules compatible with hydrocarbonaceous systems or systems based on nitrocellulose.

Another example of a suitable pigment for the tinter material includes a dry pigment blend, comprising the steps of providing at least two pigments, providing a liquid carrier, mixing the two pigments and the liquid carrier to form a liquid pigment mixture, and drying the liquid pigment mixture to form a dry pigment blend. By mixing the pigments in the liquid state, and then drying them, it is possible to produce a dry pigment blend which can be added to a base paint to produce a coloured coating composition. By appropriate selection of a mixture of single pigments, it is possible to create a wider range of colors than if only single pigment was used.

Suitable single pigments for the tinting materials are those available from S.A. Color of or those available from Clarient under the trade designation of 38 Old Road of Duclair LP 116, 76380 Canteleu, France under the trade designation of Effercol for a dustfree and autosoluble dye. Another non-exclusive example is the pigment dyes for dispersion dyeing from aqueous media such as Cosmenyl dyes available from Clariant, 500 Washington Street, Coventry, R.I., USA as well as pigments available from Elementis, Dugussa or Merck GmbH and combinations of any of these.

By mixing the pigments in the liquid state, a homogenous mix of the individual pigments is established which gives the dry pigment blend the appearance of being both uniform in color, and indicative of the color hue of the colored coating composition. Furthermore, the fact that a homogenous mix of the pigments is established means that the size of the dry pigment blend particles is not critical in giving the appearance of being uniform in color, and thus it is possible avoid the hazards associated with fine particles. This contrasts to the dry grinding of individual pigments where the particles need to be ground below a certain size to give a uniform color appearance. The issue of particle size is of particular concern since the mixing of the dry pigment blends with the base coating composition process takes place at the home of the consumer.

The method of producing a dry pigment blend for use in the present invention involves firstly selecting an appropriate number, and quantity of pigments required to produce a coating composition 38 of the desired color. Typically, about eight to sixteen pigments are required to produce a significant color range of coating compositions, although frequently three or four are required for a particular color. In this embodiment, the desired colour requires three coloured pigments, pigment 20 in the form of Copper phthalo Cyanine 15:3 (blue), pigment 22 in the form of Carbon Black, and pigment 24 in the form of Quinacridone (magenta).

Each of the pigments 20,22,24 is provided in a respective pigment carrier 21,23,25 with the combination of each pigment dispersed in the pigment carrier being referred to as tinters 31,33,35. The component breakdown of each of the tinters 31,33,35 is given in Tables 1 to 3 below.

TABLE 1

| Tinter material 31 | | Percentage by |
|---|---|---|
| Components | Chemical Name | weight |
| Solvent | Water | 34.7 |
| Humectant | Propylene Glycol | 2.5 |
| Humectant | Polyethylene Glycol | 4.2 |
| Wetting Agent | Ethoxylated phosphated alcohol | 0.96 |
| Dispersing Agent | Fatty acid ethanolamide | 7.62 |
| Defoamer | Polysiloxane | 0.3 |
| Colored Pigment | Copper phthalocyanine | 44.4 |
| Filler Pigment | Aluminium Silicate | 5.0 |
| Preserving Agent | Bronopol/(CIT/MIT) | 0.3 |

TABLE 2

| Tinter material | | Percentage by |
|---|---|---|
| Components | Chemical Name | weight |
| Solvent | Water | 44.17 |
| Humectant | Propylene Glycol | 2.4 |
| Humectant | Polyethylene Glycol | 4.20 |
| Dispersing Agent | Soya Lecithin | 1.57 |
| Dispersing Agent | Fatty acid ethanolamide | 6.04 |
| Defoamer | Polysiloxane | 0.3 |
| Coloured Pigment | Carbon Black | 20.01 |
| Filler Pigment | Aluminium Silicate | 21.01 |
| Preserving Agent | Bronopol/(CIT/MIT) | 0.3 |

TABLE 3

| Tinter material 35 | | Percentage by |
|---|---|---|
| Components | Chemical Name | weight |
| Solvent | Water | 59.08 |
| Humectant | Propylene Glycol | 2.6 |
| Humectant | Polyethylene Glycol | 4.28 |
| Wetting Agent | Ethoxylated phosphated alcohol | 2.66 |
| Dispersing Agent | Soya Lecithin | 3.69 |
| Dispersing Agent | Fatty acid ethanolamide | 2.79 |
| Defoamer | Defoamer | 0.3 |
| Coloured Pigment | Quinacridone | 24.3 |
| Preserving Agent | Bronopol/(CIT/MIT) | 0.3 |

It can be seen from Tables 1 to 3 that each of the tinter materials primarily includes the pigment and a solvent in this case water, and further additives 27. In this embodiment, the further additives 27 include a wetting agent, dispersing agents, preserving agents, a defoamer, a humectant, and a filler pigment. The function of these further additives is well known, and furthermore it is understood that the specific chemical examples, quantities and necessity of some of the additives will vary. For example, certain coloured pigments require less quantities of filler pigment. Typical ranges for further additives are given below in Table 4.

TABLE 4

| | Percentage by |
|---|---|
| Further Additives | Weight |
| Wetting Agent/Dispersing Agent | 0-15 |
| Preserving Agent | 0-0.5 |
| Defoamer | 0-0.5 |
| Humectant | 0-15 |
| Filler Pigment | 0-55 |
| Water | 20-60 |

In this embodiment the pigments 20,22,24 are provided in the form of tinters, i.e. the form in which they would be supplied for use in in-store or in-factory tinting machines where the tinters are added in liquid form directly to a base paint. This is advantageous since the pigments have already been dispersed within the pigment carrier to form the tinter, and therefore require less mixing to produce a homogenous mixture than if the pigments were supplied in dry form.

It will be appreciated that the pigment carrier need not contain all of the components listed in Table 1. For example, some pigment/solvent combinations do not require the use of wetting agents/dispersing agents to sufficiently wet and disperse the pigment, and therefore in alternative embodiments it is envisaged that the pigment carrier need not contain such additions. This highlights another advantage of using a pigment carrier formulation prepared for use with in-store and factory tinting machines, since those pigments requiring these additions to enable dispersion in the solvent will already include the correct addition. Similarly, any other additives deemed essential for a particular pigment, will also be present in the pigment carrier. The pigment carrier need only contain a solvent, be that aqueous or non-aqueous which acts to carry the pigment in the liquid state.

A suitable wetting agent would be an anionic surfactant, and a suitable dispersing agent would be a non-ionic surfactant.

The three tinters 31,33,35, i.e. the pigment carriers 21,23,25 with the pigments dispersed therein, are then mixed together with a pigment extender 40, the components of which are given below in Table 5, to produce a liquid pigment mixture 28 comprising the three tinters 31,33,35 and the pigment extender 40.

TABLE 5

| Pigment Extender 40 | | Percentage by |
|---|---|---|
| Components | Chemical Name | weight |
| Solvent | Water | 30.75 |
| Wetting Agent | Ethoxylated phosphated alcohol | 7.0 |
| Dispersing Agent | Fatty acid ethanolamide | 4.6 |
| Preserving agent | Bronopol/(CIT/MIT) | 0.1 |
| Filler Pigment | Aluminium Silicate | 57 |
| Defoamer | Polysiloxane | 0.55 |

The percentage breakdown of the tinters 31,33, 5 is given in Table 6 below which shows the combined total is 15% of the total weight of the liquid pigment mixture 28, the remaining 85% consisting of the pigment extender 40. It will be appreciated that the total weight of the liquid pigment mixture need not be limited to 15%, with typical quantities of up to 30% being used depending on the final colour required.

TABLE 6

| Liquid Pigment Mixture 28 | Percentage by |
|---|---|
| Components | weight |
| Pigment Extender 40 | 85 |
| Tinter 31 | 6.77 |
| Tinter 33 | 1.50 |
| Tinter 35 | 6.73 |

In an alternative embodiment, the pigment extender need not contain ethoxylated phosphated alcohol (anionic surfactant) with the non-ionic surfactant having a volume of 11.6% as shown below in Table 7.

TABLE 7

| Pigment Extender | | Percentage by |
|---|---|---|
| Components | Chemical Name | weight |
| Water | Water | 30.75 |
| Dispersing Agent | Fatty acid ethanolamide | 11.6 |
| Preserving agent | Bronopol/(CIT/MIT) | 0.1 |
| Filler Pigment | Aluminium Silicate | 57 |
| Defoamer | Defoamer | 0.55 |

For the avoidance of doubt, the combination of the pigment carriers 21,23,25 and the pigment extender 40 form a liquid carrier which enables the pigments 20,22,24 to be mixed in the liquid state.

It can be seen that the pigment carriers include those additives listed in Tables 1 to 3. In an alternative embodiment, those additives can be partially or wholly included in the pigment extender, i.e. the pigment extender may include all those additives listed in Tables 1 to 3, or the pigment extender may include some of the additives with the remainder in the pigment carrier, or the pigment extender may include a specific quantity of some or all of the additives, with the remaining quantity required of some or all of the additives in the pigment carrier.

In this embodiment, the tinters and the pigment extender are mixed in a high speed disperser 26 for twenty minutes. Any form and time of mixing is envisaged, providing the end result is a homogenous dispersion of pigments in the liquid carrier. It can be seen that in this embodiment the individual pigments are provided in a liquid pigment carrier, and more specifically in the form the pigments would be supplied for use in in-store and in-factory tinting machines.

In an alternative embodiment it is possible to supply the individual pigments in dry powder form, and then mix the dry powders with a liquid carrier to produce the liquid pigment mixture. The liquid carrier can be provided in the form of a pigment extender alone such that the dry pigments are added to and mixed with the pigment extender only. Alternatively, the liquid carrier can be provided in the form of a pigment carrier such that the dry pigments are mixed with the pigment carrier only.

However the liquid carrier is formulated, the principle requirement is that it enables the dry pigments to be mixed in the liquid state such that a homogenous mix of pigments is produced, and therefore in its simplest form, the dry pigment blend of the present invention can be achieved by mixing the dry pigments in a liquid, providing the dry pigments are readily dispersible in the liquid, be that through the use of a surfactant or dispersing agent and/or through careful selection of the pigment/liquid combination, and/or through the energy inputted during the dispersion of the pigments in the liquid carrier.

Certain dry pigments can be supplied already modified by surface treatments, which enable to the pigment to be more easily dispersible and stable in a liquid carrier, and thus the liquid carrier need not require any additives to enable dispersion of the modified pigments in the liquid carrier.

If individual dry pigments are provided, as opposed to pigments already dispersed in a liquid carrier, a greater intensity of mixing may be required to produce a homogenous dispersion of the pigments in the liquid pigment mixture.

The liquid pigment mixture can be dried using conventional drying techniques, for example, drying in an oven so as to produce a dry pigment blend, i.e. a mixture of the pigments in dry particle form. In this embodiment the dried mixture includes the other additives described above, although in the case where no additives are required, i.e. the pigments are carried in water only, the dried mixture will only contain the dry pigments themselves.

in the case of oven drying, the liquid pigment mixture is dried for six to eight hours at seventy degrees centigrade, although it will be appreciated that the drying time and temperature can be varied.

It is also possible to subject the dry pigment blend to additional process steps such as grinding if it is considered necessary, or filtering the blend to remove any unwanted particles and/or particles above or below a certain size.

Another suitable technique for drying the liquid pigment mix is spray drying. This is particularly advantageous since the spray drying process can be controlled to alter the particle size and shape. It will be appreciated that any filtering required can take place after the blend has dried, and/or during the spray drying process itself.

Whilst it will be appreciated that the drying process can be controlled to alter the particle size of the dry pigment blend, it should be noted that one of the significant advantages of the present invention is the fact that by mixing the pigments in the liquid state, a more homogenous mix of the individual pigments is created which gives the dry pigment blend the appearance of being uniform in colour hue, regardless of the particle size of the individual pigment particles. This contrasts to the dry grinding of pigments which results in a uniform colour blend, but with particles below 10 microns in size. The issue of particle size is of particular concern since the mixing of the dry pigment blend with the base coating composition process takes place at the home of the consumer.

It will be appreciated that by careful selection of different colored individual pigments, and their quantities, a significant color range of different dry pigment blends can be produced.

Another suitable pigment for use in tinting materials for use in the present invention can include coloring agents characterized in that they are present in a solid form mixed with an effervescent agent in a binder which is principally composed of polyethylene glycol wherein they are previously diluted at a temperature which is higher than the fusion temperature of said binder. Suitably, the method for the production of said coloring agents involves a dry mixture of two constituents introduced in a powdery form prior to the heating of said mixture, resulting in the fusion of the binder. These colorant utilize the fact that polyethylene glycol in molten state is able to easily dissolve large amounts of the chemicals constituting organic coloring matters, and in addition, for an equal weight of dye compound the solid compound containing them in intimate mixture with the binder, as it is obtained after cooling, has a better solubility or at least is more quickly soluble in water and aqueous media, compared to the original micronic powder.

According to the addition of an effervescent agent can be adjusted in order to get the best ability of the final product, i.e. the mixture in solid state, to quickly dissolve in water, and its nature is selected to ensure its solubility in efficient proportions in the binder. Such an effervescent agent can advantageously be selected from combinations able to generate carbonic acid that are non toxic and acceptable in the food industry. A typical example for such a combination is a mixture in approximately stoechiometric proportions of citric acid and sodium carbonate both these products being easy to dissolve in the binder with no effervescent reaction as long as the mixture is not in contact with water. In this method for manufacturing coloring matters or dyestuffs, chiefly comprising diluting an organic dye compound in powder form in a molten binder, the latter being principally made of polyethylene glycol advantageously admixed with an effervescent agent, and cooling the resulting mixture in order to obtain a coloring matter in solid form in which the coloring matter is intimately mixed with the binder.

In particular, as regards the manufacturing process, the initial coloring matter is preferably a powder of micronic grain size, the polyethylene glycol is also preferably in powder form, and the two powder components are advantageously mixed in the dry state before being heated at a temperature high enough to ensure melting of the binder. As far as suitable components of the products are concerned, it should be noted that the polyethylene glycol is a polyolefin class polymer which is used in a quality corresponding to a relatively low polymerisation rate, so that it is not only highly soluble but it is further fusible at a temperature below 120.degree. C. Practically, the preferred quality of polyethylene glycol or homologous or equivalent compounds are those with which melting can be performed at temperatures between 40 and 80.degree. C. Should it be only for economical reasons, it is always worth it that heating at a gentle temperature be sufficient, and in addition one has to avoid effects that could damage the coloring matter. But further it is desirable to obtain a product in solid form at ambient temperature that can also stand to temperature variations in users plants.

On the other hand, although it can be contemplated that the mixture of a micronized powder of dye compound with the binder in the final solid product be sufficiently intimate to avoid any production of spoiling micronic dust, it is preferable to ensure complete true dissolution of the dye compound during its dilution in the binder. It should however be understood that the invention includes cases where dissolution is only apparent, each micronic sized particle being individually embedded, in the binder. In a similar way it is usual in industrial practice to give the name of dyes to mineral pigments when, because of their ultra, small, grain size, their behaviour is such that their diluted form can be considered as a true solution. In connection therewith the invention provides for starting preferably with a powder dye of particle size low than 100 microns and advantageously between 10 and 50 microns.

Similar fine grain size conditions are recommended when it is intended to directly introduce the compound into the separately already molten binder which is then a viscous liquid. In the case when, according to preferred embodiments of the invention, the mixture is first prepared in the dry state, the introduction of polyethylene glycol in divided form is preferably performed using particle sizes of the order of a millimeter, since economical reasons (mainly considering the costs for the starting matters) lead to prefer a particle size above 500 microns.

Similar conditions also can apply to the effervescent agent components completing the composition. In particular, the latter are preferably also in solid powder form and they are blended dry with polyethylene glycol, before or during its admixture with the dye compound.

The proportions of the components can be highly variable, depending in particular upon their respective physicochemical properties. They can also vary according to the dimensions desired for the final product. The latter will also be highly variable according to the particular application the product is designed for. For example, for a product in a solid and highly divided form, namely for making a pourable product, made of grains or similar elements and delivered in bulk, it is advantageous to prefer a composition with a lower polyethylene glycol content than for a product finally in brick or lump form requesting shaping by moulding or possibly by extrusion.

In an alternative approach the tinting material can be prepared by mixing the ingredients of the particulate or pulverulent phase (organosilicone particles, fillers and pigments) and by then adding a fatty phase with stirring, the mixture subsequently being milled, sieved, then poured into a dish and compacted. The milled and sieved mixture of the pulverulent phase and of the fatty phase is compacted using a press, such as by applying a pressure ranging from 0.5 MPa to 10 MPa. In one embodiment of the present disclosure, the milled and sieved mixture of the pulverulent phase and of the fatty phase is compacted by applying a pressure ranging from 1 MPa to 5 MPa. The composition thus obtained is provided in the form of a compact powder.

Suitable tinting materials will allow for the safe and easily attained reproducibility of colors and shades, and the wide range of shades. As a whole, for each workshop using a coloring matter designed according to the invention, the correct dosage of coloring matter is easy to secure, since the concentration is constant in the delivered product and the latter can possibly be supplied in unidose amount corresponding to any appropriate weight. Moreover, the tinting material can contain a mixture of various organic dye compounds, in order to obtain any color at will. With control of the appropriate composition preservation of the desired shade for a given dosage can be obtained. The user has no longer to fear consequences of mistakes or lacks of care in the weighing of each dose of the individual dye compound with the pre-dosed amount in the pouch.

A suitable tinting material can have a composition including 10 to 80%, preferably 15 to 60% of polyethylene glycol (PEG) with respect to the total weight of the composition. The dye proportion is advantageously between 10 and 70%, preferably between 30 and 50%, with respect to the composition total weight. As far as the effervescent agent is concerned, in ternary mixtures, it is advantageously present at a level of 10 to 60%, preferably 15 to 50%, with respect to the composition total weight. In any case, whether the total composition include an effervescent agent or not, the best results seem to be obtained when the binary mixture with polyethylene glycol contains 0.5 to 1.5 part in weight of polyethylene glycol for one part of the initial coloring compound.

As regards the final product as it is presented in solid state, it must be noted that it can be under the shape of grains or granules in bulk, the dimensions of which are between 0.2 and 10 millimeters thus roughly of the order of a millimeter. Such granules can be obtained by direct precipitation from the molten mixture of the components. One can also obtain dimensionally non isotropic elements, similar to vermicelli, cut out from a yarn having also a diameter of the orders of a millimeter, obtained by extrusion of the viscous paste of the molten mixture while it is being cooled down. Blocks can also be obtained by moulding in a great variety of moulds of various shapes and dimensions, from pellets to bricks.

The filling of the tinting material into the pouch or encapsulant layer can be in a horizontal form/fill/seal apparatus, individual pouches can be formed by folding the polymeric film in half followed by providing vertical seals along the length of the folded sheet and separating the pouches along the seals formed by vertical sealing. Optionally, the bottoms of the pouches can also be sealed. After the pouch is formed and filled, the top of the pouch is sealed. Similarly, in vertical form/fill/seal apparatus, the continuous sheet can be formed around a tube and the sheet is immediately joined together by a longitudinal sealing jaw as either a lap seal or a fin seal. For additional information regarding such packaging systems, see U.S. Pat. Nos. 4,671,049; 4,807,420; 4,090,344; and 4,937,112 all of which are hereby incorporated by reference.

A second sealing function is present in a vertical form/fill/seal configuration which consists of a combination top and bottom seating section (with a bag cut-off device in between). The top-seating portion seals the bottom of an empty bag suspended from the bag forming tube while the bottom portion seals the top of a filled bag.

In most processes for packaging products, the package is formed and filled by creating a heat seal between two opposed sheets of polymeric film to form a pouch and almost simultaneously sliding or dropping the tinting material into the pouch. In these form and fill packaging techniques a continuous flat sheet of polymeric film is fed around a form which shapes it into a tube, the tube is slipped over a hollow form and the free edges of the tube are sealed together. The tube so formed is then passed between a pair of hot sealing jaws which create a series of discrete pouches by collapsing the film onto itself and forming a seal by the application of heat and pressure. The product is introduced into each pouch through the hollow form in the interval between the heat seals. During high operating speeds, the tinting material can be dropped into the pouch while the sealing jaws, which form the seal, are closed. With both vertical and horizontal form and fill sealing applications the heat seal should be strong enough to support and retain the substance after the sealing jaws open to release the film. It is often desirable to release the sealing jaws soon after the seal is formed so a film which accomplishes this by exhibiting a high “hot tack” is very useful, Hot tack refers to the strength of the heat seal immediately following the sealing operation.

Additionally, in packaging applications there is a great demand for heat sealable films which can be subjected to temperatures high enough to seal the films without causing the substrate to cockle or pucker. One approach for achieving this is by coating a film substrate with a layer of heat sealable material which adheres strongly to the substrate and which can be melted at a temperature below the softening temperature of the substrate. Heat-sealable coatings with low melting temperatures are often preferred because the substrate is less likely to be damaged during heat sealing.

After the pouch is formed, filled and sealed one or more of the pouches can be filled into a moisture resistant pack that reduces the risk of premature dissolving of the pouch in humid environment prior to use in tinting coating compositions. Suitable moisture resistant containers include glass jars with lids and film packages such as those of U.S. Pat. No. 5,419,960 which discloses a film with a low temperature sealable coating. The coating contains a copolymer of ethylene and acrylic or methacrylic acid U.S. Pat. Nos. 6,077,602 and 5,843,582 disclose heat sealable film coatings containing a terpolymer produced from a nitrile monomer, an acrylate or 1,3 butadiene monomer, and an unsaturated carboxylic acid or sulfoethyl methacrylate. U.S. Pat. Nos. 6,013,353 and 5,827,615 disclose metallized films with heat sealable coatings, on the surface of the metal, containing a copolymer of a carboxylic acid and an acrylate, or acrylonitrile or mixtures thereof.

In the preparation of films useful for packaging purposes having moisture resistant properties, the outside of the film or the side of the film which comes in direct contact with the hot sealer surfaces should have good hot slip and jaw release characteristics. Additionally, the film should have good machinability so that the wrapped product ran be conveyed easily through the overwrapping machine without sticking to adjacent packages or the parts of the machine with which it comes into contact, which can cause production delays. Acrylic-containing coatings which offer these properties are known. The acrylic-containing coating is applied to one side of the film substrate and another heat sealable coating, such as polyvinylidene chloride (PVdC), or another acrylic coating, is coated on the other side. Acrylic-containing coating formulations provide the film with a good coefficient of friction, which contributes to good machinability characteristics. These acrylic-based coatings also provide films with good barrier characteristics, which improve flavor and aroma protection. Such coatings are described in U.S. Pat. Nos. 4,058,649 and 4,058,645. The PVDC coating or other type of acrylic coating is usually on the inside of the film and provides high seal strength, good hot tack characteristics and barrier properties. These heat sealable coatings have glass transition (“Tg”) temperatures which are higher than room temperature. Such a coated film is disclosed in U.S. Pat. No. 4,403,464. Also U.S. Pat. No. 4,456,741 discloses heat sealable terpolymer compositions useful as pressure-sensitive adhesives for use with a backing material such as paper, polyester film or, foamed polymers. The terpolymer heat sealable pressure-sensitive adhesive composition comprises butyl acrylate, N-vinyl-2-pyrrolidinone and styrene. Other heat sealable coatings are disclosed in UE and East German Patent DD-146,604. The coating may be applied to polymeric substrates having other coatings or overlayers such as a metallized layer. The films with the metallic layer can be filled with the one or more pouches and then heat sealed. In such applications, generally speaking, the faster a package is routed through the filling and seating process, the more economic the packaging process. Therefore, it is advantageous for the packing film to have a low minimum seal temperature to reduce the process residence time necessary to reach the minimum seat temperature. Of course, it is understood that the minimum seat temperature must not be too low so as to avoid activation of the seating properties during storage or transit at high atmospheric temperatures. Moreover, the higher the seal strength of the heat seal immediately following the sealing operation, the faster the package may be processed thereafter without risking an unacceptably high seal failure rate. This characteristic, known as “hot tack”, is a measure of the cohesive strength of the heat seat during the cooling stage before solidification of a heat seat. Hot tack is determined by tearing a seal apart to measure the seal strength immediately after the seal is formed and before it cools down. Hot tack is measured in force per unit of seal width. Generally, the higher the hot tack the better since this will promote faster processing and handling of the sealed package. Suitable laminate layers for the package includes metalized foil paper layer laminated to a cast polypropylene layer and another layer of PET, polyethylene or EVOM. There may be a fourth layer which can be from the cast polypropylene laminate material retains its Filled shape even as the product is removed from the pouch so that the pouch can even be shaped like a traditional cylindrical can but more suitably stored in a moisture-proof package including, e.g.: sealed metal foil pouches. These are for example of a flexible nature, such as of flexible plastics material or metal foil or laminates of these materials, but they can also be for example be rigid in nature, such as of rigid plastics material or metal or glass.

The pouches of the present invention provide a system that can deliver not only deeper shades of a monochromatic color, but also can deliver within one pouch, blended tinters to deliver one color. Also, pouches with two different color tinters in each one of them can be used to deliver another color. i.e. blue and a yellow at different amounts to achieve a shade of green. In the method of adding one or more pouches to fluid unpigmented or tint base waterborne coating compositions even greater flexibility is achieved in making and marketing compositions with a variety of colors by paint manufacturers and retailers, who can decide on the size of the system, or the number of colors to be offered, since the system is easy to customize, including by having fewer or greater numbers of bases, to expand or reduce the number of colors offered to account for market size as well as regional preferences, to provide greater versatility in the layout or organization of the colors in the rack and as a result of one or more of the above objectives to provide a cost savings, as compared to previous equipment ladened systems. The pouches of the present invention can have tinting materials formulated for additions to such compositions as tint bases, Examples include bases which are—any one of a predetermined number of liquid coating compositions comprising the vehicle, binder, various additives and, optionally, titanium dioxide, to which the pouch is added. The base can be of the water borne type (e.g., latex) or the even a solvent borne type (e.g., alkyd with a solvent dissolvable encapsulant). The paint retailer can maintain a minimum of tint bases in inventory of each of the different types of bases required to custom-mix with the colorants to obtain the colors displayed on the take-home cards, color selection and identification panels, color chips and other merchandising or sales aids provided for the system. Suitable bases include one or more of Pastel Base—a base containing from 1.7 to 2.5 pounds, but preferably from 2.0 pounds to 2.2 pounds of titanium dioxide and comprising 124-128 fluid ounces; up to 2 ounces of colorant can be added to provide about a gallon (128 ounces) of paint. A pastel base without colorant contains sufficient hiding power to be used as a paint due to its titanium dioxide content. Tint Base—a base containing from 1.5 to 2.0 pounds, but preferably from about 1.5 pounds to 1.68 pounds of titanium dioxide in 122-126 fluid ounces, from two ounces to four ounces of colorant can be added to provide about a gallon of paint. Deep Base—a base containing from 0.5 to 1.0 pounds, but preferably from 0.50 pounds to 0.68 pounds of titanium dioxide in 118-124 fluid ounces; up to eight ounces of colorant can be added to provide about a gallon of paint. Accent Base—a clear or transparent base consisting of 112-118 fluid ounces containing no titanium dioxide, up to twelve ounces of colorant can be added to provide about a gallon of paint Alkyd Paint—paints using alkyd resins as vehicles; these paints are thinned with solvent, such as mineral spirits.

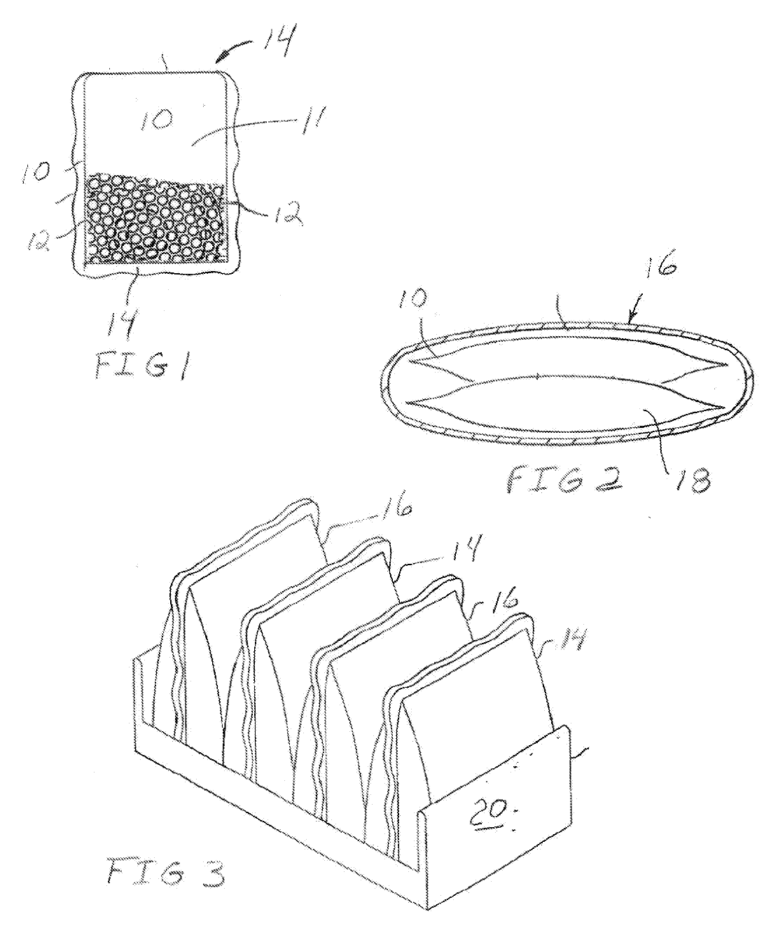

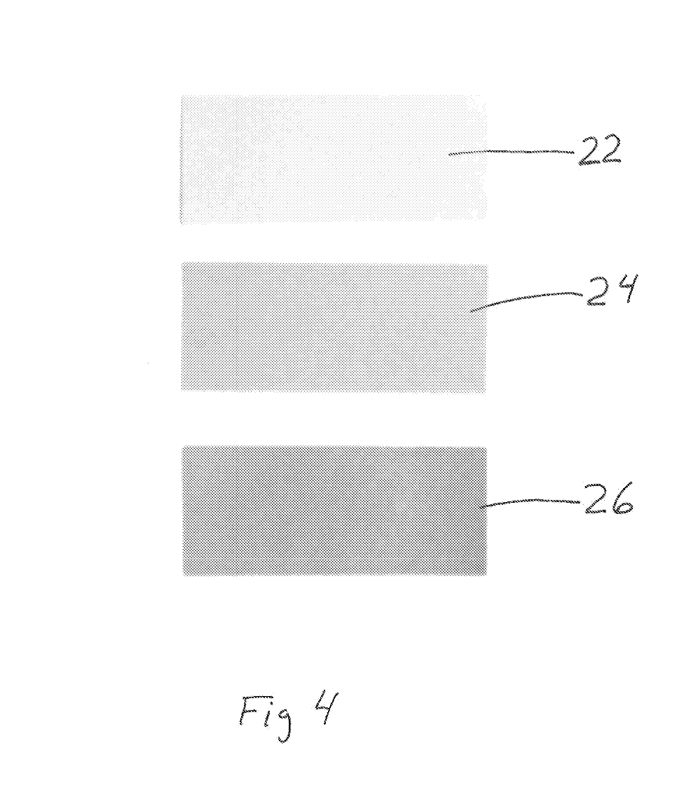

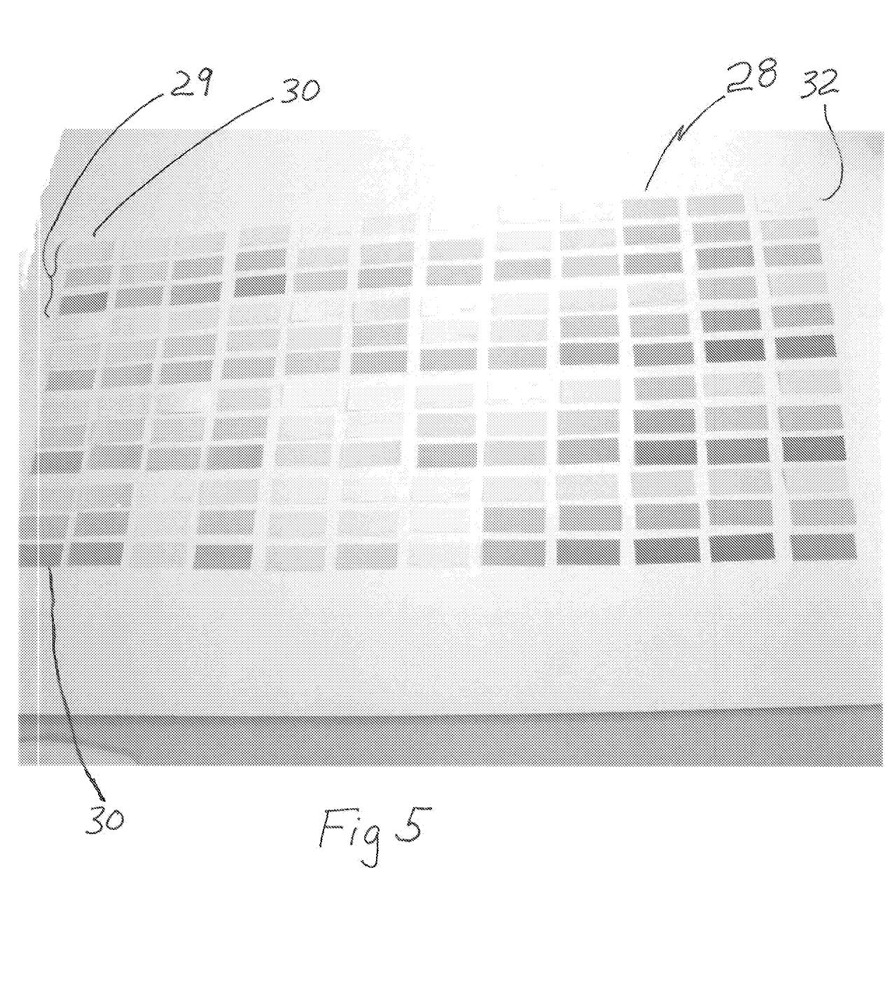

in the drawings FIG. 1 shows a moisture resistant package 14 is skematically depicted as surrounding pouch 10. Pouch 10 is shown in a cut away view having the water soluble polymeric layer, 11 and cut away section 12 showing the particulate tinting material. FIG. 2 of the drawings shows cross-sectional view of a moisture resistant package having a plurality of pouches within package 16 in which 10 and pouch 18 can provide different shades or colors for a containing having the coating composition and effective headspace for agitation. FIG. 3 shows a kit 20 having a plurality of moisture resistant packages 14 or 16. The kit shows that the packages can be arranged such that one pouch can be present in the package or a plurality of pouches can be present in a package. A moisture resistant package with a plurality of pouches, such as that of FIG. 2 can be used to produce the range of shades of color depicted in FIG. 4. A plurality of three pouches, could be present in one moisture resistant package or in three separate moisture resistant packages to produce a light shade 22, a medium shade 24 or a deeper shade 26. In the method of adding the pouches to any tint base paint, the pouch for shade 22 can be added first. If the user wants a deeper shade, the pouch for shade 24 can also be added to the same tint base. If still a deeper shade is desired, the third pouch can be added to the same tint base to produce shade 26. FIG. 5 shows the range of color in a system of pouches, ranging from colors of column 32 to column 33 and row 32 to row 34. Each pouch would have tinting material to produce the shade as depicted for instance at reference 29. There three pouches would be used in a manner similar to that described for FIG. 4. Reference 28 shows the three shades of FIG. 4. So with a system of pouches for addition to a minimum of tint bases, a retailer can provide to the user various color schemes for matching colors in other decorating materials such as furniture, draperies, linens and the like.

### EXAMPLES

The examples of three random colors were created by a cumulative addition. A 20 ml pouch, with tinting material was stirred in and that achieved color number 1, or the tightest color. The other two were additions to this color to produce two darker shades. The formula was,
20 ml—Color 1
20+40 ml—Color 2
20+40+60 ml—Color 3

The concept is around the customer tinting the lightest (20 ml) color, painting a 1′×1′ square on the wall, and judge whether or not you wanted to go darker to the next shade on the box. If so, add the 40 ml to that and achieve the mid shade color and repeat painting a square on the wall. Repeat the process with the 60 ml pouch to achieve the darkest shade. Hopefully this explanation helps as it is really not that complex at this point.

### Example 1 Color Control

A 20, 40, and 60 ml pouch of tinter was added to paint in sequence and stirred in to achieve a specific color. After each pouch was added it was then painted on a card, and judged to be the color desired, or whether you wanted to go darker to the next shade on the card. If so, add the 40 ml to that and achieve the mid shade color and repeat brush out on a card. Repeat the process with the 60 ml pouch to achieve the darkest shade. When developed, the colors were tinted using the stir in method, drawn down on leneta cards dried and measured against a known color standard both spectrophotometrically and visually.

Pouch Filling Process:

After determining the colors, the tinter was weighed into paper cups. PVA films were then cut to size, again based on tinter volume, and sealed on three sides using a “Clamco Model 250” thermal sealer Mfg. by Clamco: 12900 Plaza Dr. Cleveland, Oh. The tinter was then poured through a funnel attached to a ring stand into the PVA pouch. The fourth side of the pouch was then sealed as above and the excess PVA was trimmed from the pouched color.

Pouch Composition: The actual size of the pouch was based on the volume of tinter being contained. For example, If I had a tinter load of 20 ml, my pouch size would be relative in proportion to the tinter.

Component 1

PVA Film—Manufactured by Monosol LLC 1701 County Line Rd. Portage Ind. 46368 under the trade name PXP6160.

Tinter Composition:

| | |
|---|---|
| Pigment Red 112 Monoazo | 5% |
| Pigment Yellow 42 | .4% |
| Pigment Violet 23 Dioxazine | .4% |
| Dispersant: - (Cocomonoethanoiamide surfactant/ | 10% |
| Phosphated ethoxylated fatty alcohol/ | |
| Phospholipid surfactant) | |
| Aluminum silicate type extender - | 80% |
| Total | 95.8% |

### Example 2 Color Works

Selecting a known color from an existing palette, the color is formulated using the method of blending pigments together. Based on the prescribed dose, the colors are then pouched inside the polymeric film. The pouches are then dropped into a gallon of paint and stirred in to achieve the prescribed color.

Pouch Composition:

PVA Film - 6 ml or Dependant on the
tinter dose as described above

| | |
|---|---|
| Pigment Green 7 - | 2.5% |
| Pigment Yellow 74 - | 2% |
| Carbon Black - | 1% |
| Dispersant - (Cocomonoethanolamide surfactant/ | 10% |
| Phosphated ethoxylated fatty alcohol/ | |
| Phospholipid surfactant) | |
| Clay extender - | 84.5% |
| Total | 100% |

We claim:

1. An article of manufacture comprising:
at least one water dispersible tinting material to be released into an water based coating composition to give the coating composition color;
encapsulating layer of at least one polymeric material that is dispersible in aqueous containing medium surrounding the tinting material wherein the layer has a thickness from about 0.5 to about 5 mils and can dissolve to release the dispersible tinting material in an aqueous coating composition having about 25 to about 45 volume percent solids and about 55 to about 75 volume percent water in less than 20 minutes with agitation at a temperature in the range of about 50 to about 110° F.

2. The article of claim 1 wherein said polymeric composition soluble in aqueous medium comprises from about 50% to about 99.9% of at least one water-soluble polymer; and from about 0.1% to about 50% of at least one principal solvent wherein the polymeric film forming composition, when formed into a film comprising a thickness of from about 20 microns to about 100 microns, and wilt dissolve in a beaker of water at a temperature below about 68° F. in less than about 5 minutes with hand agitation.

3. The article of claim 1, wherein the water-soluble polymer is selected from at least one polyvinyl alcohol, pullulan, starch and/or hydroxyalkylated starch.

4. The article of claim 1, wherein the at least one film layer formed from the polymeric composition wilt dissolve in latex paint having a volume percent of solids in the range from 35 to 40% at a temperature in the range of about 50° F. to about 100° F. in less than about 2 minutes with hand agitation.

5. The article of claim 1, wherein the water-soluble polymer comprises a mixture of two water-soluble polymers having disparate molecular weights.

6. The article of claim 5, wherein the water-soluble polymer comprises a first polymer having a molecular weight greater than about 50,000.

7. The article of claim 5, wherein the ratio of high to low molecular weight polymers is greater than about 50/50.

8. The article of claim 2, wherein the polyvinyl alcohol is at least partially hydrolyzed.

9. The article of claim 8, wherein the polyvinyl alcohol is less than about 90% hydrolyzed.

10. The article of claim 8 wherein the polyvinyl alcohol is a mixture of at least two polyvinyl alcohol materials, the two polyvinyl alcohol materials having different levels of hydrolysis.

11. The article of claim 2, wherein the principal solvent is an alcohol.

12. The article of claim 1, additionally containing a surfactant.

13. The article of claim 2, wherein the principal solvent is a diol.

14. The article of claim 13, wherein the principal solvent is a cyclohexanedimethanol.

15. The article of claim 1, wherein the tinting material is a particulate product produced by the steps of:
providing a mixture of at least one water-soluble pigment, dye, or optical brightener, with an extender, and optionally, at least one member selected from the group consisting of: at least one hydrophilic surfactant, further additives, to produce a mixture;
dry-compacting said mixture to obtain a dry-compact;
granulating said dry-compact to obtain a granulated dry-compact; and
treating said granulated dry-compact with a dust-binding oil to produce a compacted granular product.

16. The article of claim 1, wherein the tinting material is a particulate product produced by the steps of:
providing a mixture of at least one pigment dispersed in water, with or without an extender, and at least one member selected form the group consisting of: at least one hydrophilic surfactant or pigment dispersant, plus further additives to produce a mixture capable of adding color to a latex paint,
rendering the mixture particulate and dry through the steps of compacting and dry grinding, or the step of spray drying.

17. The article of claim 1, wherein the tinting material is a particulate product produced by the steps of:
providing a mixture of at least one pigment dispersed in water or solvent, with or without an extender, and at least one member selected form the group consisting of, at least one hydrophobic stabilizer or pigment dispersant, plus further additives to produce a mixture capable of adding color to a solvent borne paint,
rendering the mixture particulate and dry through the steps of compacting and dry grinding, or the step of spray drying.

18. The colored paint derived from adding the article of claim 17 to a waterborne paint, which includes but is not limited to alkyds oils, and non-aqueous dispersions.

19. Article according to claim 15, wherein the compacted granular product further comprising at least one hydrophilic surfactant, and having a particle size in the range from 0.1 to 3 mm.

20. Article according to claim 16, wherein the compacted granular product has a particle size in the range of 0.3-1 mm.

21. Article according to claim 1 wherein the encapsulating layer of the polymeric material is a pouch with sealed edges to contain the granular tinting material.

22. The pouch of claim 21, wherein the pouch body comprises a fold made of the polymeric material folded on itself to form a folded side of the pouch, the layer being being sealed to itself to form at least two further sides of the pouch.

23. The pouch of claim 22 wherein the solid phase rests on the folded side of the pouch.

24. The pouch of claim 22 wherein the sides of the pouch are inclined toward each other.

25. The pouch of claim 22 wherein the pouch has a shape selected from a tetrahedron square, or rectangular planar.

26. At least one pouch of claim 22 in a moisture resistant enclosure.

27. A process of making the pouch of claim 1, wherein the process comprises filing the pouch with a particulate tinting material.

28. A process of making the pouch of claim 27, wherein the process comprises filling the pouch with a liquid and, subsequently, structuring the liquid, to form the solid phase.

29. A system for tinting coating compositions, comprising, an encapsulant of at least one water-soluble polymeric film; and
at least one tinter or colorant disposed within the encapsulant where the tinter is dispersible in the coating composition in an effective amount to provide a color to the coating composition.

30. The system of claim 29 wherein the tinter has one or more pigments and additives and is water dispersible.

31. The system of claim 30 wherein the coating composition is a non-pigmented or white tint base latex paint or stain.

32. The system of claim 30 wherein the water-soluble polymeric film is selected from the group consisting of collagen derivatives, cellulose derivatives, pullulan, homo- and copolymers of vinyl pyrrolidone, homo or copolymers of vinyl alcohol, homo- and copolymers of acrylic and methacrylic acids, and salts and esters thereof, starch derivatives, gums, alginates, vegetable proteins, hellac, crotonic acid polymers, adipic acid polymers, carageenans, and mixtures thereof.

33. The system of claim 30, wherein the water-soluble polymer film is water soluble at temperature in the range of about 40 to 110° F.

34. A kit for delivering a tint to a coating composition, comprising a unit package containing the system of claim 29.

35. The kit of claim 34, having a plurality of systems of claim 1 so that different tinters are available in separate encapsulants to color the coating composition.

36. The kit of claim 35 having a plurality of systems of claim 1 so that different tinters are available in separate encapsulants to provide a variety of colors for tinting the coating composition.

37. The kit of claim 35 wherein the tinting material is selected from i) a dry pigment blend comprising at least two pigments, in which the dry pigment blend has an average particle size between ten and twenty five microns and appears uniform in color hue; and ii) a dry pigment blend comprising at least two pigments, the dry pigment blend being suitable for mixing with a base coating composition so as to form a colored coating composition, in which the dry pigment blend has a color hue which is indicative of the color of the colored coating composition.

38. The kit of claim 29 wherein the water-soluble polymeric film is selected from the group consisting of collagen derivatives, cellulose derivatives, pullulan, homo- and copolymers of vinyl pyrrolidone, homo- or copolymers of vinyl alcohol, homo- and copolymers of acrylic and methacrylic acids, and salts and esters thereof, starch derivatives, gums, alginates, vegetable proteins, hellac, crotonic acid polymers, adipic acid polymers, carageenans, and mixtures thereof.

39. The kit of claim 29 wherein at least one system is contained in a moisture resistant layer.

40. The kit of claim 39 wherein the moisture resistant layer is a metallic foil layer in the form of a sealed pouch.

41. The kit of claim 39 wherein a plurality of systems of claim 1 are present in a moisture resistant layer where each system has has a different tinter to provide the coating composition a range of different colors ranging from different shades of the same monochromatic color to give a deeper color to pigments blended together to obtain additive colors.

42. A method of tinting a water based coating composition, comprising: adding at least one system from the kit a table active agent which comprises incorporating the labile active agent into a composition comprising a water-soluble polymeric film and drying the composition to form a film.

43. The method of claim 42 wherein the water-soluble polymeric film is selected from the group consisting of collagen derivatives cellulose derivatives, pullulan, homo- and copolymers of vinyl pyrrolidone, homo- or copolymers of vinyl alcohol, homo- and copolymers of acrylic and methacrylic acids, and salts and esters thereof starch derivatives, gums, alginates, vegetable proteins, hellac, crotonic acid polymers, adipic acid polymers, carageenans, and mixtures thereof.
